(19) United States
(12) Patent Application Publication
(10) Pub. No.: US 2015/0109328 A1
(43) Pub. Date: Apr. 23, 2015

(54) TECHNIQUES FOR NAVIGATION AMONG MULTIPLE IMAGES

(71) Applicant: Google Inc., Mountain View, CA (US)

(72) Inventors: David Gallup, Bothell, WA (US); Steven Maxwell Seitz, Seattle, WA (US)

(73) Assignee: GOOGLE INC., Mountain View, CA (US)

(21) Appl. No.: 14/056,505

(22) Filed: Oct. 17, 2013

(51) Int. Cl. G06F 3/0484

(52) U.S. Cl. CPC G06F 3/04845
USPC 345/629; 345/619; 345/660

(57) ABSTRACT

Aspects of the disclosure relate generally to providing a user with an image navigation experience. In order to do so, a reference image may be identified. A set of potential target images for the reference image may also be identified. An area of the reference image is identified. For each particular image of the set of potential target images an associated cost for the identified area is determined based at least in part on a cost function for transitioning between the reference image and the particular target image. A target image is selected for association with the identified area based on the determined associated cost functions.

### BACKGROUND

Various systems allow users to view images in sequences, such as in time or space. In some examples, these systems can provide a navigation experience in a remote or interesting location. Some systems allow users to feel as if they are rotating within a virtual world by clicking on the edges of a displayed portion of a panorama and having the panorama appear to “move” in the direction of the clicked edge.

### SUMMARY

Aspects of the disclosure provide computer-implemented method. The method includes identifying, by one or more computing devices, a reference image; identifying, by the one or more computing devices, a set of potential target images for the reference image; identifying, by the one or more computing devices, an area within the reference image; for each particular potential target image of the set of potential target images, determining, by the one or more computing devices, an associated cost for the identified area based at least in part on a cost function for transitioning between the reference image and the particular potential target image; and selecting, by the one or more computing devices, a given potential target image for association with the identified area of reference image based on the determined associated cost functions.

In one example, the method also includes receiving user input from a client computing device and providing for display, using the one or more computing devices, the given potential target image to the client computing device, wherein the identified area of the reference image is identified based at least in part on the user input. In another example, the associated cost is determined as a weighted sum of one or more cost terms. In another example, selecting the given potential target image includes selecting a potential target image of the set of potential target images having a lowest-valued associated cost. In another example, determining the cost function for each particular potential target image of the set of potential target images includes determining a centering cost term between the reference image and the particular potential target image, and wherein the centering cost term is configured to be minimized when a projection of the identified area is located at a center of the particular potential target image. In another example, determining the cost function for each particular potential target image of the set of potential target images includes determining an alignment cost term between the reference image and the particular potential target image, and wherein the alignment cost term is configured to be minimized when a surface normal from the identified area is located opposite of a viewing direction of the particular potential target image. In another example, determining the cost function for each particular potential target image of the set of potential target images includes determining a zoom cost term between the reference image and the particular potential target image, and wherein the zoom cost term is configured to be minimized when a relative zoom value between the reference image and the particular potential target image is equal to a particular zoom factor. In this example, the method also includes determining the particular zoom factor based on a distance between the selected area and a center of the reference image. In another example, determining the cost function for each particular potential target image of the set of target images includes determining an overlap cost term based on an amount of overlap between the reference image and the particular potential target image. In another example, the method also includes associating the given target image with the identified area; receiving, from a client computing device, a request for a target image, the request identifying the identified area and the reference image; retrieving the given target image based on the identified area and the association; and providing the given target image to the client computing device.

Another aspect of the disclosure provides a system comprising one or more computing devices. These one or more computing devices are configured to identify a reference image; identify a set of potential target images for the reference image; identify an area within the reference image; for each particular potential target image of the set of potential target images, determine an associated cost for the identified area based at least in part on a cost function for transitioning between the reference image and the particular potential target image; and select a given potential target image for association with the identified area of the reference image based on the determined associated cost functions.

In one example, the one or more computing devices are also configured to receive user input from a client computing device and provide for display, using the one or more computing devices, the given target image to the client computing device, wherein the identified area of the reference image is identified based at least in part on the user input. In another example, the one or more computing devices are also configured to determine the associated cost by using a weighted sum of one or more cost terms. In another example, the one or more computing devices are also configured to select the given potential target image by selecting a potential target image of the set of potential target images having a lowest-valued associated cost. In another example, the one or more computing devices are also configured to determine the cost function for each particular potential target image of the set of potential target images by determining a centering cost term between the reference image and the particular potential target image, and wherein the centering cost term is configured to be minimized when a projection of the identified area is located at a center of the particular potential target image. In another example, the one or more computing devices are also configured to determine the cost function for each particular potential target image of the set of potential target images by determining an alignment cost term between the reference image and the particular potential target image, and wherein the alignment cost term is configured to be minimized when a surface normal from the identified area is located opposite of a viewing direction of the particular potential target image. In another example, the one or more computing devices are also configured to determine the cost function for each particular potential target image of the set of potential target images by determining a zoom cost term between the reference image and the particular potential target image, and wherein the zoom cost term is configured to be minimized when a relative zoom value between the reference image and the particular potential target image is equal to a particular zoom factor. In this example, the one or more computing devices are also configured to determine the particular zoom factor based on a distance between the selected area and a center of the reference image. In another example, the one or more computing devices are also configured to determine cost function for each particular potential target image of the set of target images by determining an overlap cost term based on an amount of overlap between the reference image and the particular potential target image. In another example, the one or more computing devices are also configured to associate the given target image with the identified area; receive, from a client computing device, a request for a target image, the request identifying the identified area and the reference image; retrieve the given target image based on the identified area and the association; and provide the given target image to the client computing device.

### BRIEF DESCRIPTION OF THE DRAWINGS

FIG. 1 is a functional diagram of an example system in accordance with aspects of the disclosure.

FIG. 2 is a pictorial diagram of the example system of FIG. 1.

FIG. 3 is an example of a client computing device and user input in accordance with aspects of the disclosure.

FIG. 4 is an example screen shot and client computing device in accordance with aspects of the disclosure.

FIG. 5 is example an image and image data in accordance with aspects of the disclosure.

FIG. 6 is another example of images in accordance with aspects of the disclosure.

FIG. 7 is an example diagram of image data in accordance with aspects of the disclosure.

FIG. 8 is another example image and image data in accordance with aspects of the disclosure.

FIG. 9 is an example of image overlap data in accordance with aspects of the disclosure.

FIG. 10 is an example of a client computing device and user input in accordance with aspects of the disclosure.

FIG. 11 is an example screen shot and client computing device in accordance with aspects of the disclosure.

FIG. 12 is another example screen shot and client computing in accordance with aspects of the disclosure.

FIG. 13 is a flow diagram in accordance with aspects of the disclosure.

FIG. 14 is another flow diagram in accordance with aspects of the disclosure.

### DETAILED DESCRIPTION

### Overview

Aspects of the technology relate to providing image navigation experiences to users and determining the best view (image) of a location in response to a user input. For example, a user may view a first image, or a reference image, on a display of a client device. In order to navigate to other images at or near the same geographic location as the reference image, the user may select a particular pixel (or region of pixels) of a reference image. For example, in some embodiments, the user may select a pixel by using a finger on a touch screen or by using a mouse pointer or other user input device. In response, the user may be provided with a target image that best that “sees” or displays that pixel in the reference image or corresponds to that pixel. In this regard, a user may navigate through a virtual tour by clicking on an area of a first image and receiving a second image that is related in time or space to that first image.

Accordingly, a target image may include an image that is provided in response to a user selection of a pixel. In order to provide these target images, for each pixel or area of the reference image, these target images may be selected using a cost function. The image which minimizes the cost function may be selected as the target image for that pixel of the reference image. This target image may then be provided for display to a user who selects the corresponding pixel of the reference image.

Each of the images is associated with a depth map and the relative pose (e.g., location and orientation) of the camera that captured the image. The depth map and relative pose may be generated using 3D reconstruction. Thus, a set of potential target images for a particular reference image may be determined based on the location and orientation information for both the particular reference image and the images of the set of potential target images.

The cost function may include various cost terms. The cost function may be optimized to select target images based on one or more of centering, alignment, zoom, and overlap cost terms. For example a centering cost term may be minimized when a projection of the clicked pixel on the reference image falls at the center of the target image. An alignment cost term may be minimized, for example, when a surface normal from the clicked pixel is opposite of the viewing direction of the target image. As another example, a zoom cost term may be minimized when the relative zoom between the reference image and the target image is equal to a desired zoom factor. This desired zoom factor may be defined based on the distance between the clicked pixel and the center of the reference image. In this regard, if the user selects a pixel that is closer to the center of the image, the zoom may be optimized to 4 times, whereas farther from the center the zoom may be optimized for 2 times, etc.

As noted above, in using the interface, the user may select a single pixel or region of an image. In the pixel example, the user may be provided with the image that minimizes the cost function for that pixel. In another example the user may select from a number of predetermined regions of interest in the currently displayed image. In order to do this, each target image may be assigned to that target image's lowest cost pixel in the reference image. The lowest of these lowest cost pixels are then selected such that no two chosen pixels are “too close” to one another in the reference image. These selected best of the best may then become available pixels (or regions) for selection by a user. Some pixels (or regions) may not be available if there are no images which meet a threshold minimum cost value. The available pixels or regions may be identified by highlighting (for example when the user moves a mouse pointer or finger over the region), outlining, displaying an icon as, or otherwise distinguishing the regions.

### Example Systems

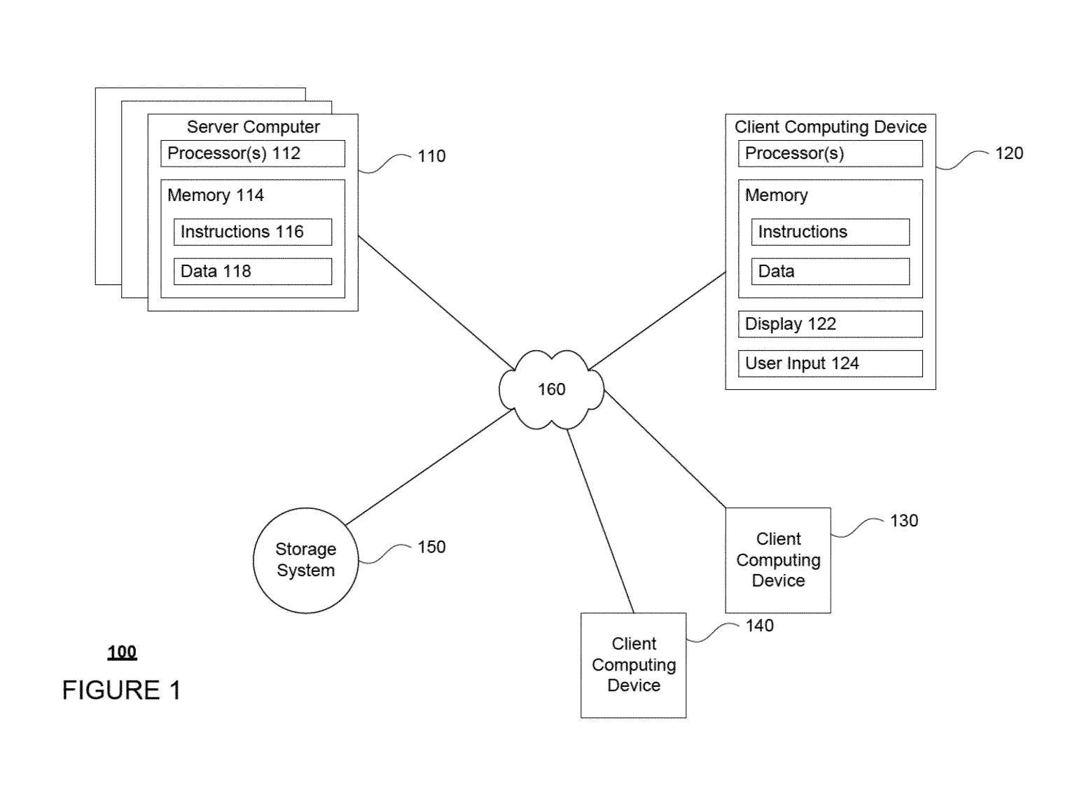

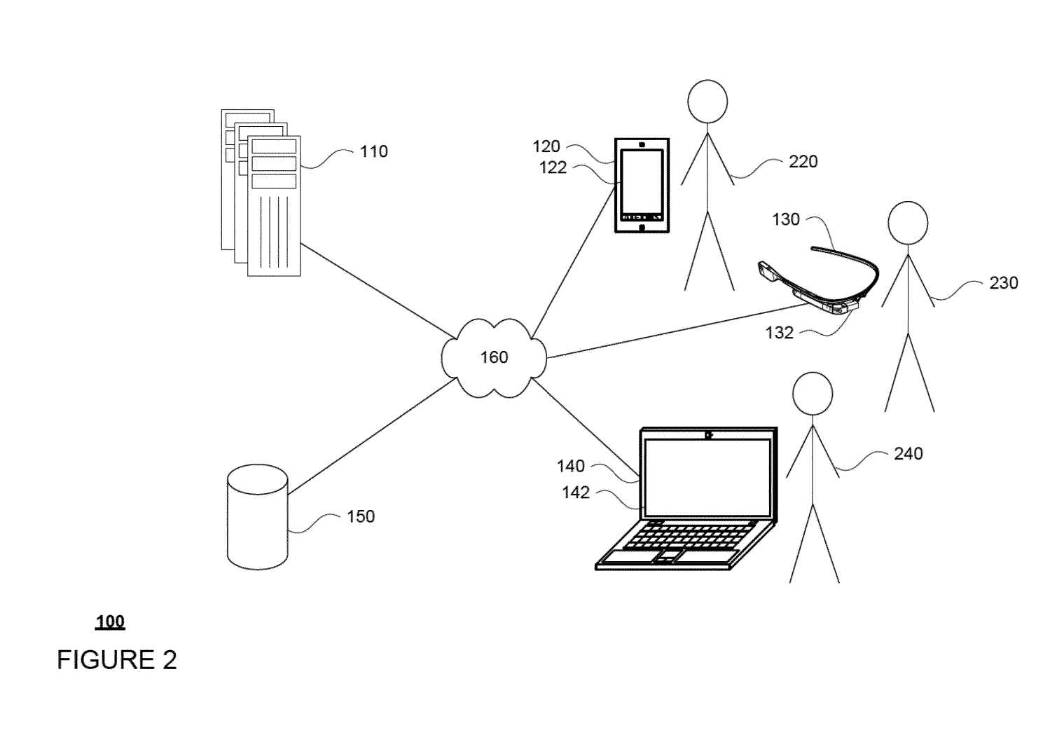

FIGS. 1 and 2 include an example system 100 in which the features described above may be implemented. It should not be considered as limiting the scope of the disclosure or usefulness of the features described herein. In this example, system 100 can include computing devices 110, 120, 130, and 140 as well as storage system 150. Each of computing devices 110 can contain one or more processors 112, memory 114 and other components typically present in general purpose computing devices. Memory 114 of each of computing devices 110, 120, 130, and 140 can store information accessible by the one or more processors 112, including instructions 116 that can be executed by the one or more processors 112.

Memory can also include data 118 that can be retrieved, manipulated or stored by the processor. The memory can be of any non-transitory type capable of storing information accessible by the processor, such as a hard-drive, memory card, ROM, RAM, DVD, CD-ROM, write-capable, and read-only memories.

The instructions 116 can be any set of instructions to be executed directly, such as machine code, or indirectly, such as scripts, by the one or more processors. In that regard, the terms “instructions,” “application,” “steps” and “programs” can be used interchangeably herein. The instructions can be stored in object code format for direct processing by a processor, or in any other computing device language including scripts or collections of independent source code modules that are interpreted on demand or compiled in advance. Functions, methods and routines of the instructions are explained in more detail below.

Data 118 can be retrieved, stored or modified by the one or more processors 112 in accordance with the instructions 116. For instance, although the subject matter described herein is not limited by any particular data structure, the data can be stored in computer registers, in a relational database as a table having many different fields and records, or XML documents. The data can also be formatted in any computing device-readable format such as, but not limited to, binary values, ASCII or Unicode. Moreover, the data can comprise any information sufficient to identify the relevant information, such as numbers, descriptive text, proprietary codes, pointers, references to data stored in other memories such as at other network locations, or information that is used by a function to calculate the relevant data.

The one or more processors 112 can be any conventional processors, such as a commercially available CPU. Alternatively, the processors can be dedicated components such as an application specific integrated circuit (“ASIC”) or other hardware-based processor. Although not necessary, one or more of computing devices 110 may include specialized hardware components to perform specific computing processes, such as decoding video, matching video frames with images, distorting videos, encoding distorted videos, etc. faster or more efficiently.

Although FIG. 1 functionally illustrates the processor, memory, and other elements of computing device 110 as being within the same block, the processor, computer, computing device, or memory can actually comprise multiple processors, computers, computing devices, or memories that may or may not be stored within the same physical housing. For example, the memory can be a hard drive or other storage media located in housings different from that of the computing devices 110. Accordingly, references to a processor, computer, computing device, or memory will be understood to include references to a collection of processors, computers, computing devices, or memories that may or may not operate in parallel. For example, the computing devices 110 may include server computing devices operating as a load-balanced server farm, distributed system, etc. Yet further, although some functions described below are indicated as taking place on a single computing device having a single processor, various aspects of the subject matter described herein can be implemented by a plurality of computing devices, for example, communicating information over network 160.

Each of the computing devices 110 can be at different nodes of a network 160 and capable of directly and indirectly communicating with other nodes of network 160. Although only a few computing devices are depicted in FIGS. 1-2, it should be appreciated that a typical system can include a large number of connected computing devices, with each different computing device being at a different node of the network 160. The network 160 and intervening nodes described herein can be interconnected using various protocols and systems, such that the network can be part of the Internet, World Wide Web, specific intranets, wide area networks, or local networks. The network can utilize standard communications protocols, such as Ethernet, WiFi and HTTP, protocols that are proprietary to one or more companies, and various combinations of the foregoing. Although certain advantages are obtained when information is transmitted or received as noted above, other aspects of the subject matter described herein are not limited to any particular manner of transmission of information.

As an example, each of the computing devices 110 may include web servers capable of communicating with storage system 150 as well as computing devices 120, 130, and 140 via the network. For example, one or more of server computing devices 110 may use network 160 to transmit and present information to a user, such as user 220, 230, or 240, on a display, such as displays 122, 132, or 142 of computing devices 120, 130, or 140. In this regard, computing devices 120, 130, and 140 may be considered client computing devices and may perform all or some of the features described herein.

Each of the client computing devices 120, 130, and 140 may be configured similarly to the server computing devices 110, with one or more processors, memory and instructions as described above. Each client computing device 120, 130 or 140 may be a personal computing device intended for use by a user 220, 230, 240, and have all of the components normally used in connection with a personal computing device such as a central processing unit (CPU), memory (e.g., RAM and internal hard drives) storing data and instructions, a display such as displays 122, 132, or 142 (e.g., a monitor having a screen, a touch-screen, a projector, a television, or other device that is operable to display information), and user input device 124 (e.g., a mouse, keyboard, touch-screen or microphone). The client computing device may also include a camera for recording video streams, speakers, a network interface device, and all of the components used for connecting these elements to one another.

Although the client computing devices 120, 130 and 140 may each comprise a full-sized personal computing device, they may alternatively comprise mobile computing devices capable of wirelessly exchanging data with a server over a network such as the Internet. By way of example only, client computing device 120 may be a mobile phone or a device such as a wireless-enabled PDA, a tablet PC, or a netbook that is capable of obtaining information via the Internet. In another example, client computing device 130 may be a head-mounted computing system. As an example the user may input information using a small keyboard, a keypad, microphone, using visual signals with a camera, or a touch screen.

As with memory 114, storage system 150 can be of any type of computerized storage capable of storing information accessible by the server computing devices 110, such as a hard-drive, memory card, ROM, RAM, DVD, CD-ROM, write-capable, and read-only memories. In addition, storage system 150 may include a distributed storage system where data is stored on a plurality of different storage devices which may be physically located at the same or different geographic locations. Storage system 150 may be connected to the computing devices via the network 160 as shown in FIG. 1 and/or may be directly connected to any of the computing devices 110, 120, 130, and 140 (not shown).

Storage system 150 may store images and associated information such as image identifiers, orientation, location of the camera that captured the image, intrinsic camera settings (such as focal length, zoom, etc.), depth information, as well as references to other, target images. For example, each image may be associated with a depth map defining the 3D location of each pixel in real world coordinates, such as latitude, longitude and altitude or other such coordinates. This depth map may be generated as a 3D reconstruction of the image using the orientation, location, and intrinsic settings of the camera. In some examples, the depth map may be generated using Patch-based Multi-view Stereo Software (“PMVS”).

In addition to the depth information, storage system 150 may also store references between images as noted above. As described in more detail below, pixels or areas of pixels within an image may be associated with references to target images. In this regard, a computing device, such as server computing device 110, may retrieve a target image based on information including an identifier of a reference image and a pixel or area within the reference image. In some examples, the target images may also be considered reference images in that pixels or areas of target images may also be associated with other target images.

### Example Methods

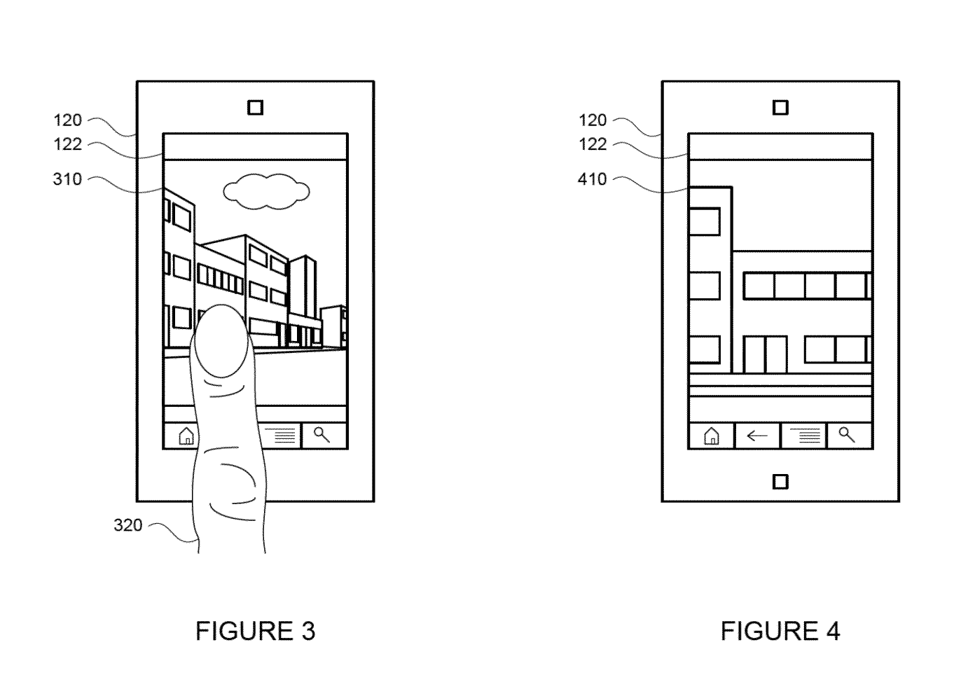

As an example, a client computing device may provide users with an image navigation experience. In this example, the client computing device may communicate with a server computing device in order to retrieve and display images. In this regard, a user may view a reference image received from a server computing device on a display of a client computing device. FIG. 3 is an example of client computing device 120 displaying a reference image 310 on display 122.

The user may navigate to other images from the reference image by selecting a pixel or region (such as an area of pixels) in the reference image. As an example, the user may select a pixel or region by using a finger 320 on a touch screen of display 122, as shown in FIG. 3. Alternatively, other types of user inputs such as a mouse pointer may be used to select the pixel or region.

In response to receiving the user input, the client computing device may retrieve and display a second image. As noted above, this second image may include a target image that displays the selected pixel in the reference image or corresponds to the selected pixel. FIG. 4 is an example display of a target image 410 on client computing device 120. In this example, the target image 410 may be an image that has been determined to display the selected pixel in the reference image 310.

In order to retrieve the target image, the client device may send a request to one or more server computing device. This request may include information identifying the reference image, such as an image identified or other reference, as well as the pixel or region that was selected. In response, the one or more server computing devices may use the image identifier and selected pixel or region to retrieve a target image from an image storage system such as storage system 150.

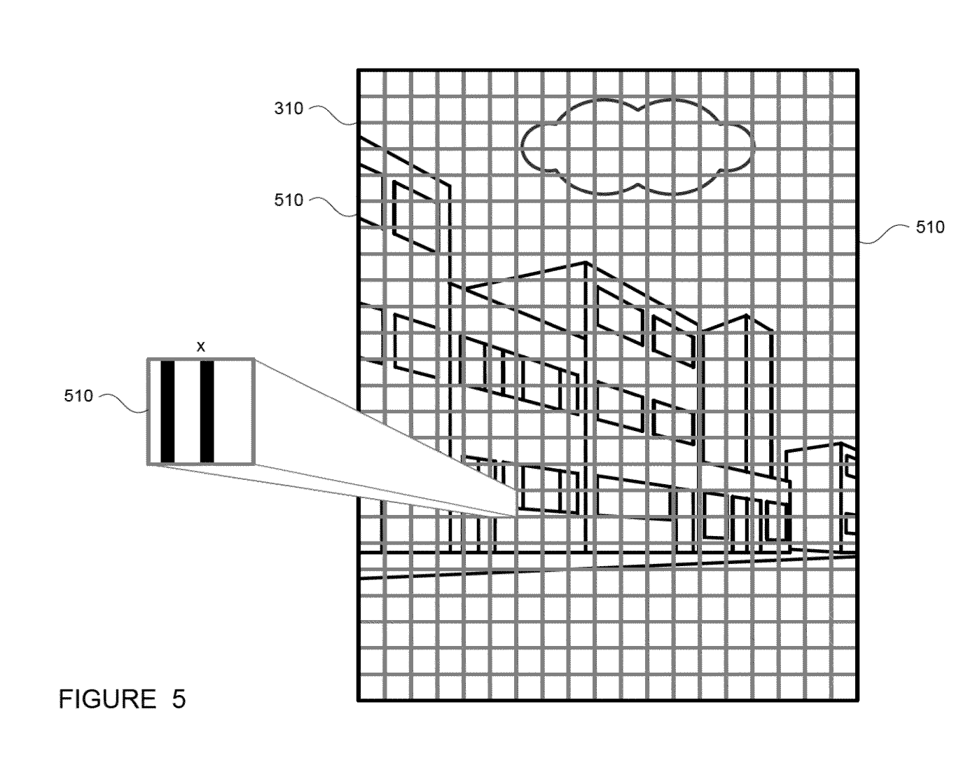

Thus, in one example, before providing images to the client computing devices, the one or more server computing devices may select a target image for each pixel of the reference image. FIG. 5 is an example of reference image 310 which includes a plurality of pixels 510. In this example, one or more of the server computing devices 110 may select a target image for each of the pixels 510 of reference image 310.

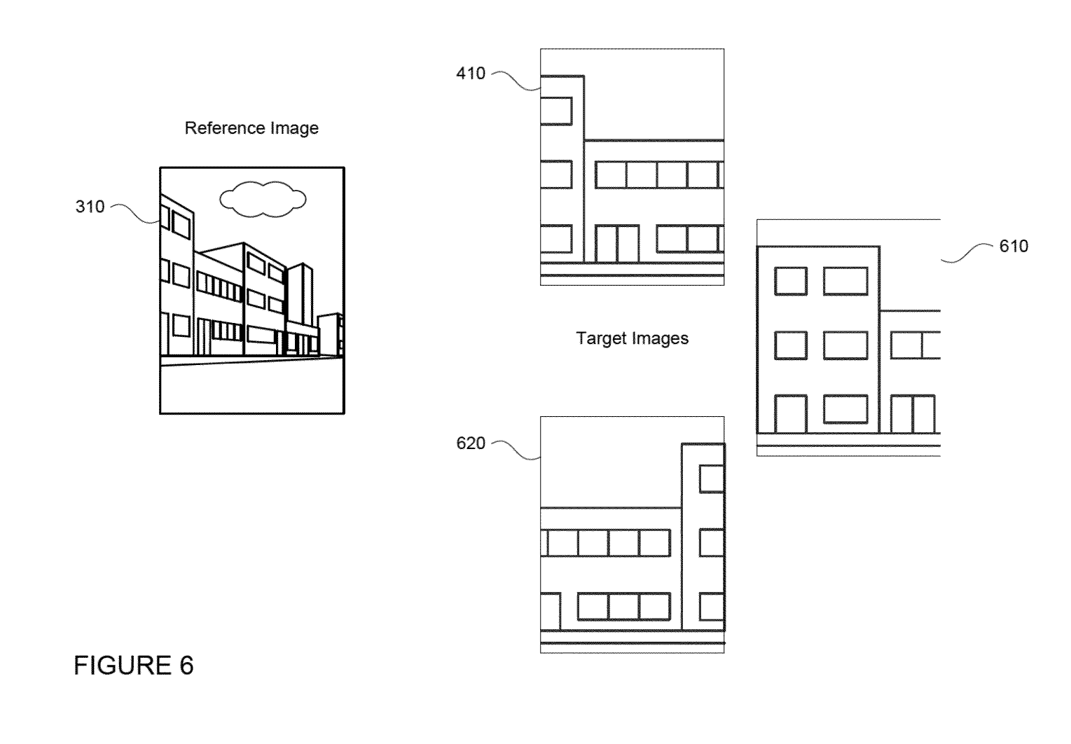

In order to select a target image, one or more server computing devices may also identify a set of potential target images for the reference image. This set of potential target images may be identified based on the location, and in some examples, orientation information of the potential target images. FIG. 6 is an example of reference image 310 as well as a set of potential target images 410, 610, and 620. In this example, each of potential target images 410, 610, and 620 were captured at a location proximate to the location where the reference image 310 was captured.

For each pixel of the reference image, one or more server computing devices may determine a plurality of cost functions, one for each potential target image of the set of potential target images. Each cost function may include various cost terms arranged as a linear equation, a weighted sum, a nonlinear equation, an exponential equation, etc. As an example, the cost function may be optimized to select target images according to one or more of centering, alignment, zoom, and overlap cost terms, though other such terms may also be used. The potential target image of the set of potential target images which minimizes this cost function may be selected as the target image. In this case, the cost terms may be selected to be minimized based on the expectation of a better user experience. The examples below relate to minimizing the cost function. However, as an alternative, the cost terms may be selected to be maximized based on the expectation of a better user experience. In this regard, the potential target image of the set of potential target images which maximize this cost function may be selected as the target image.

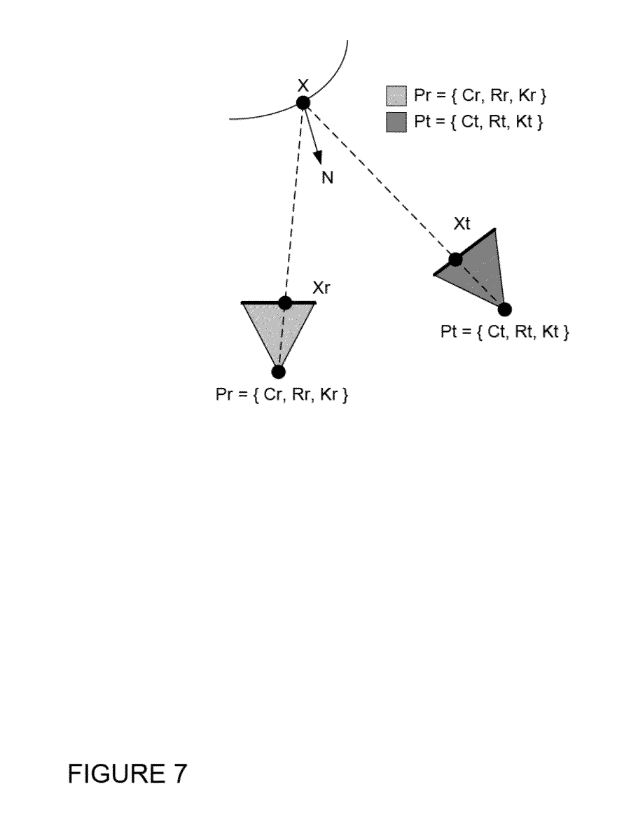

FIG. 7 is an example diagram that will be used to demonstrate some of the cost terms mentioned above. In this example, Pr may represent the camera that captured the reference image and Pt may represent the camera that captured a target image of the set of target images. These cameras may be defined by the camera's center “C”, rotation “R”, and intrinsic camera parameters “K” (such as zoom, focal length, etc.). Each respective camera's center and rotation may define that camera's position and orientation in the world, while the intrinsic parameters may define how points in the camera's coordinate system are mapped to pixels of the image captured by that camera. Thus, Pr, the “reference” camera, may be defined by the parameters Cr, Rr, and Kr. Similarly, Pt, the “target” camera, may be defined by the parameters Ct, Rt, and Kt.

In this example, “X” may represent the 3D point under the ray corresponding to the pixel Xr which was or will be selected by a user. The reference “N” corresponds to an outward facing surface normal of the point X. This surface normal may be determined from the 3D depth map data for the reference and/or target images.

In order to provide a more natural image navigation experience, when a user selects a pixel of a reference image, the 3D location that that pixel represents should be close to the center of the target image for that pixel. By doing so, the target image displayed to the user in response to the user's input will focus on the part of the reference image that was selected or clicked on by the user. Thus, if the potential target image that minimizes the cost function will be selected as the target image for that pixel, the centering cost term may be minimized when a projection of the selected pixel on the reference image falls at the center of the target image. In this example, the centering cost term for a given target image and pixel of the reference image may be defined using an equation such as c_center(Pt)=∥p(Pt, X)−c(Pt)∥. Here, “p” may represent the projection of the point X in the target image, and “c” may represent a function which returns a center point of the image. Thus, as the projection of point X in the target image becomes closer to the target image, this example of a centering cost term will be minimized.

It may also be pleasing to the user when the selected pixel is viewed frontally or “head on” in the target image. In this example, the surface normal for the selected pixel would point opposite of a viewing direction of the target image. Thus, if the potential target image that minimizes the cost function will be selected as the target image for that pixel, the alignment cost term may be minimized, for example, when a surface normal from the clicked pixel is opposite of the viewing direction of the target image. In this example, the centering cost term for a given target image and pixel of the reference image may be defined using an equation such as: c_align(Pt)=1 dot(N, v(Pt)). Here, “v” may represent a function that returns the viewing direction of an image and “dot” refers to a dot product. For linear perspective cameras (which include most cameras in use today), the rotation R is a 3×3 matrix. In such an example, the viewing direction of the image may be the last row of R or the z-axis of the camera.

In some examples, it may be appropriate to show a user an image that “zooms in” on the selected pixel. In this regard, the target image provided to the user may include a “close up” of the features at or near the selected pixel. Thus, if the potential target image that minimizes the cost function will be selected as the target image for that pixel, the zoom cost term may be minimized when the relative zoom between the reference image and the target image is equal to a desired zoom factor. In some examples, this desired zoom factor may be selected based on the distance between the selected pixel and the center of the reference image.

A zoom factor may describe how the apparent size of objects change between two images. For example, consider a unit sphere centered at X. Project that sphere into the image and measure its diameter in pixel units: diameter(P, X)=2 f/z. In this example, z=dot(v(P), X C), which measures the distance to the point X along the viewing direction. C and f are properties of P, the camera center and focal length respectively. Using this example, the ratio between the diameters in two different photos is the zoom factor, or: zoom=diameter(Pt, X)/diameter(Pr, X). With this definition, zoom can be achieved either by increasing the focal length or by moving the camera closer to X. An example equation for the zoom cost may thus be: c_zoom(Pt)=|log desired_zoom/zoom|. In this example, the logarithmic scale may be useful because the server computing device may be measuring ratios. For example, the difference between 4 times zoom and 2 times zoom would be the same as the difference between 2 times zoom and 1 times zoom.

As noted above, the desired zoom factor may be selected as a function of the distance of the selected pixel from the center of the reference image. For example, if a user selects a pixel that is relatively close to the center of the image, the target image may have a greater zoom, such as 4 times the zoom of the reference image, than if the user selects a pixel on the periphery of the image. In this example, the desired zoom factor may be 2 times the zoom of the reference image. The desired zoom factor may also be linearly interpolated so that if the user clicks halfway between the center and the periphery, the target image provided may have an intermediate zoom level, or using the previous example, a desired zoom of 3 times the zoom of the reference image.

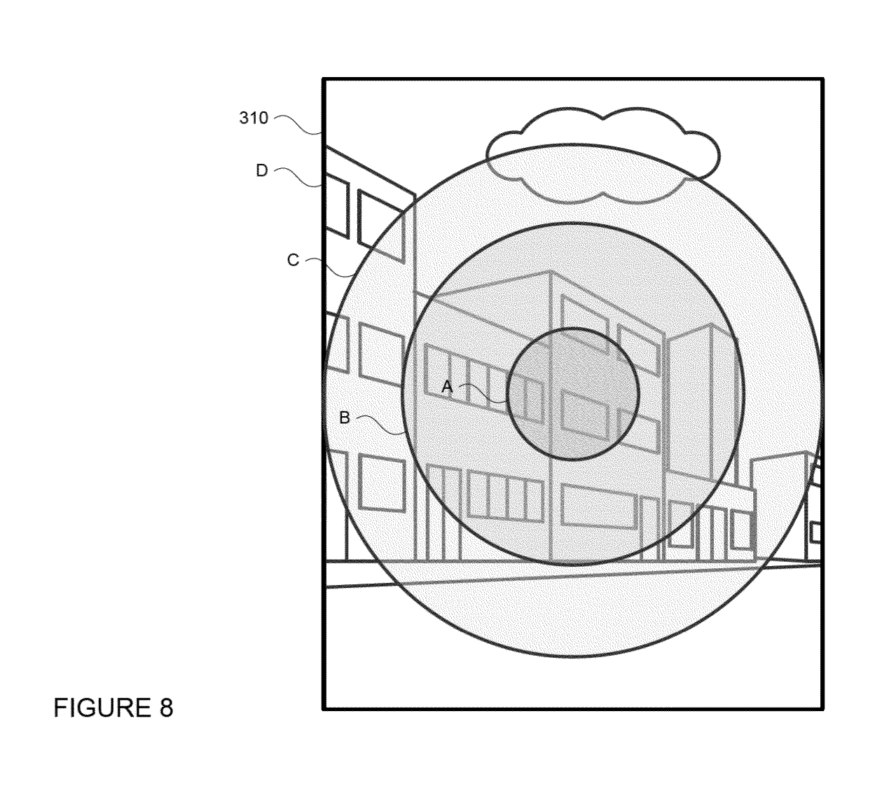

FIG. 8 is an example of reference image 310 and different desired zoom levels A, B, C, and D. The desired zoom levels are arranged in concentric circles where the center point of these circles corresponds to the center of the reference image 310. As an example, the desired zoom level for pixels within circle A may be 4 times the zoom of the reference image, the desired zoom level for pixels between circle A and circle B may be 3 times the zoom of the reference image, the desired zoom level for pixels between circle B and circle B may be 2 times the zoom of the reference image, the desired zoom level for pixels between outside of circle C and within the edges boundaries of the reference image D may be the same as the zoom of the reference image, though other desired zoom factors may also be used.

The user navigation experience may also appear to be more cohesive when there is a greater amount of overlap between the reference image and the target image. Overlap may be defined as the percentage of pixels which are visible between two images. Thus, if the potential target image that minimizes the cost function will be selected as the target image for that pixel, the overlap cost term may be minimized when the reference image and the target image completely overlap.

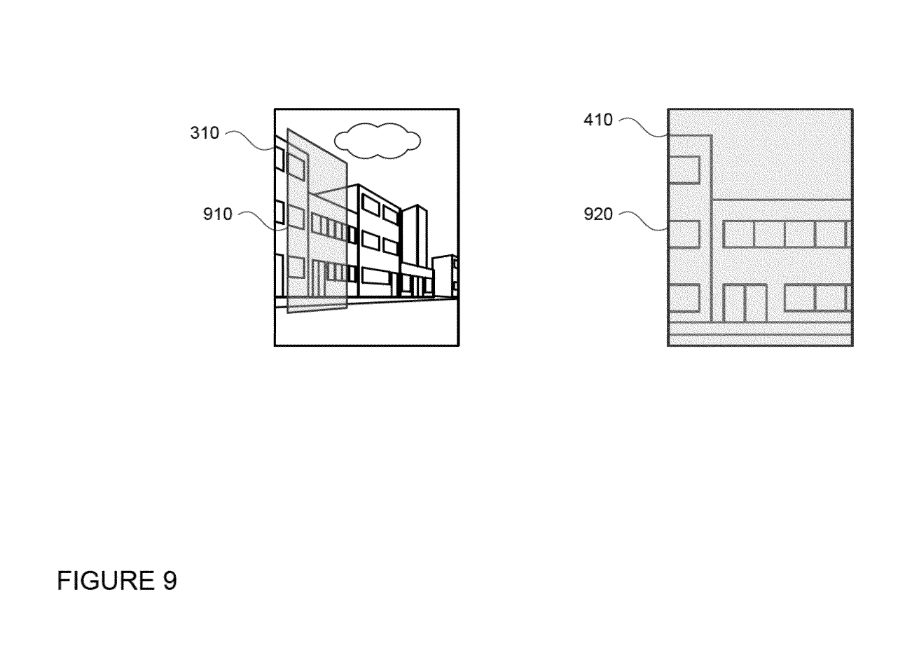

FIG. 9 is an example of a reference image 310 and target image 410. Area 910 of reference image 310 demonstrates the region of overlap between the target image 410 and the reference image. Area 920 of target image 410 demonstrates the region of overlap between the reference image 310 and the target image. Thus, overlap can be based on both as the number of pixels of the reference image that project into the target image (within the image boundaries) as well as the number of pixels in the target image which are projected into the reference image. The former measures how much of the reference image are within (or seen by) the target image, and the latter measures how much of the target image is covered by the reference image. An example equation for the overlap cost term may be: c_overlap=(1−#_of_pixels_within/#_of_pixels_Reference)+(1#_of_pixels_covered/#_of_pixels_Target). Thus, in this example, each of these two terms of the overlap cost term may range from 0 to 1.

Using the example cost terms described above, if the cost function is arranged as a weighted sum, an example cost function for a particular pixel of a reference image and a particular potential target image Pt may be: cost(Pt)=w_center*c_center(Pt)+w_align*c_align(Pt)+w_zoom+c_zoom(Pt)+w_overlap*c_overlap(Pt). The weight parameters w_center, w_align, w_zoom, and w_overlap, describe how much each cost term is to be preferred. These weights may all be the same (for example, all 1) or different values.

As noted above, a cost function for a particular pixel of a reference image may be determined for each potential target image of the set of potential target images. The potential target image of the set of potential target images having the lowest cost value may be selected as the target image for that particular pixel. This target image may be associated with the particular pixel of the reference image, and the associated stored in memory, such as storage system 150 described above. This association may then be used to identify and provide target images to client computing devices as described above.

As a further alternative, rather than being computed and stored in storage system 150 before being provided to client computing devices, a target image for a particular pixel or area of a reference image may be computed in real time by one or more server computing devices in response to a request for a target image from a client computing device or by a client computing device in response to receiving the user input selecting a pixel or region of a reference image.

In addition, rather than sending a request in response to receiving user input selecting a pixel or region of a reference image, the client computing device may retrieve the target image from local memory of the client computing device. For example, when the one or more server computing devices provides the reference image to the client device, the server computing device may send one or more target images with the reference image. In another example, if all of the reference and target images are stored locally at the client device, the client device may simply retrieve the needed images from the local storage.

Regarding the user interface, the user may select a single pixel or region of a reference image displayed on a client computing device. In the single pixel example, the user may be provided with the target image that minimizes the cost function for that pixel. In the region example, the user may be provided with the target image that minimizes the cost function for that region of pixels.

In addition, in the region example, the regions may be predetermined. In order to do this, the server computing device may assign each particular potential target image of a set of potential target images to that particular potential target image's “best” pixel in the reference image. The “best” of these best pixels are then selected such that no two chosen pixels are “too close” to one another in the reference image. An example of this proximity threshold may be within a distance of some percentage, such as 5%, of the image height of the reference image.

In one example, a target image may be associated with the pixel for which that target image has the lowest cost function. In another example, the “best” pixel for particular potential target image t can be obtained by taking the 3D point X for the center pixel in the potential target photo and projecting it into a reference photo. This may yield a 2D point xt for the potential target photo t. A cost ct for each of these points can be defined by computing cost(Pt) using xt as the point selected by a user. A set S of target photos that minimizes the following can be computed:

Sum_{—}{t in S}ct,

subject to

ForAll_{—}{t1,t2 in S}∥xt1−xt2∥>P_{—}TH*reference_photo_height,

And

ForAll_{—}{t1 in S and t2 not in S}∥xt1−xt2|<=P_{—}TH*reference_photo_height.

Here, P_TH may represent the proximity threshold to ensure that the potential target images are not too close. In other words, the potential target images with smaller ct values, but that are not too close, and we must choose any photo that is not too close to another chose photo. The final constraint of the above equation may be used to avoid the trivial solution of not choosing any potential target images for the set of potential target images.

One or more server computing devices may then select the lowest cost potential target image using the following approach:

Initialize S to the empty set.
Initialize T to the set of all target photos.

### Do {

For all t in T, choose t′ with the smallest ct.

Add t′ to S.

Remove any t from T whose xt is too close to xt′.

} While T is not empty.

These target images selected as best of the best may then become available pixels or regions for selection by a user. Some pixels or regions may not be available if there are no images which meet a threshold minimum cost value.

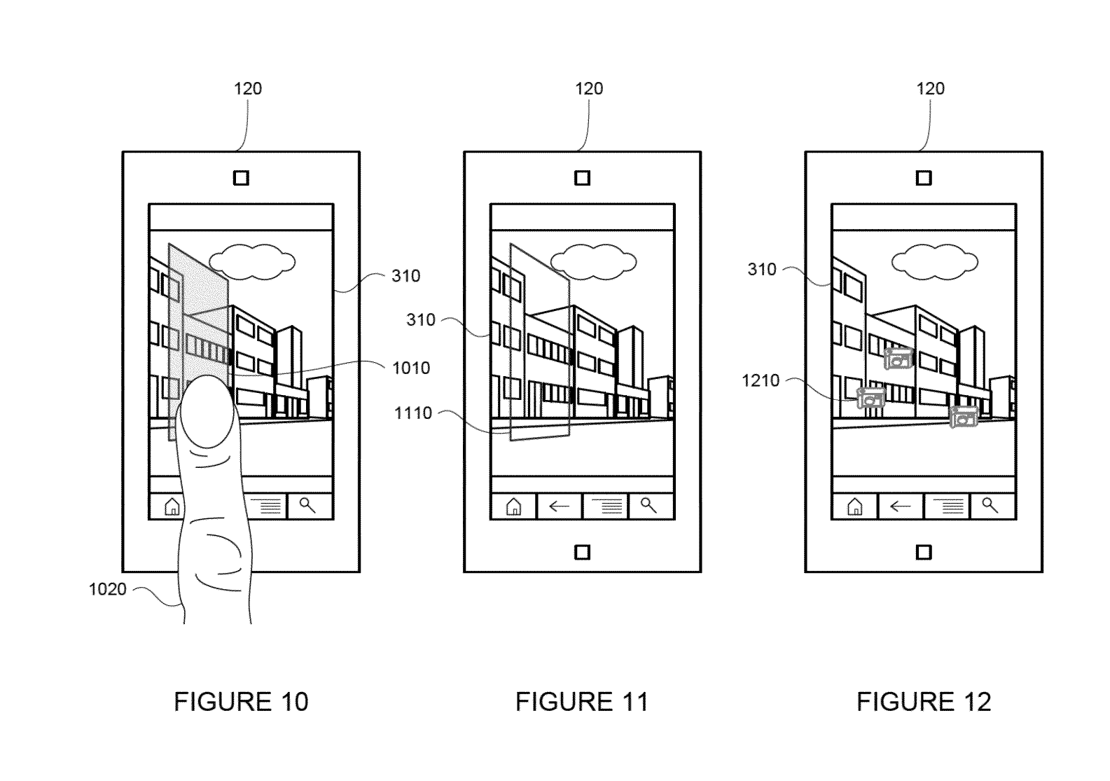

The available pixels or regions may be identified to the user in various ways. For example, FIG. 10 depicts a region of pixels 1010 using highlighting. In this example, when the user moves a mouse pointer or finger 1020 over the region, the region changes color or becomes highlighted or shaded. FIG. 11 is an example of identifying an available region 1010 by outlining the region. FIG. 12 is an example of identifying a region by displaying an icon 1210 in the area of the region. By identifying these regions to users, the user is able to easily determine where and what target photos are available and request them easily.

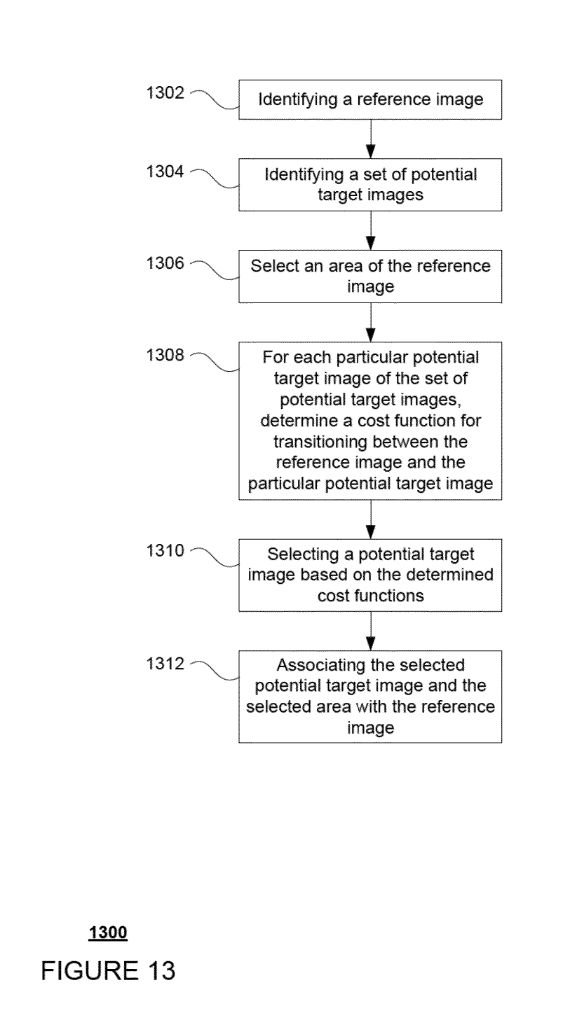

FIG. 13 is an example flow diagram 1300 of some of the aspects described above which may be performed by one or more server computing devices, such as the server computing devices 110. In this example, the one or more server computing devices identify a reference image at block 1302. The one or more server computing devices also identify a set of potential target images for the identified reference image at block 1304. A pixel or area of pixels of the reference image is selected at block 1306. For each particular potential target of the set of potential target images, the one or more server computing devices determine a cost function for transitioning between the reference image and the particular potential target image at block 1308. The one or more server computing devices then select a potential target image as a target image for the selected area based on the determined cost function at block 1310 and associate the selected potential target image with the selected area of the reference image at block 1312.

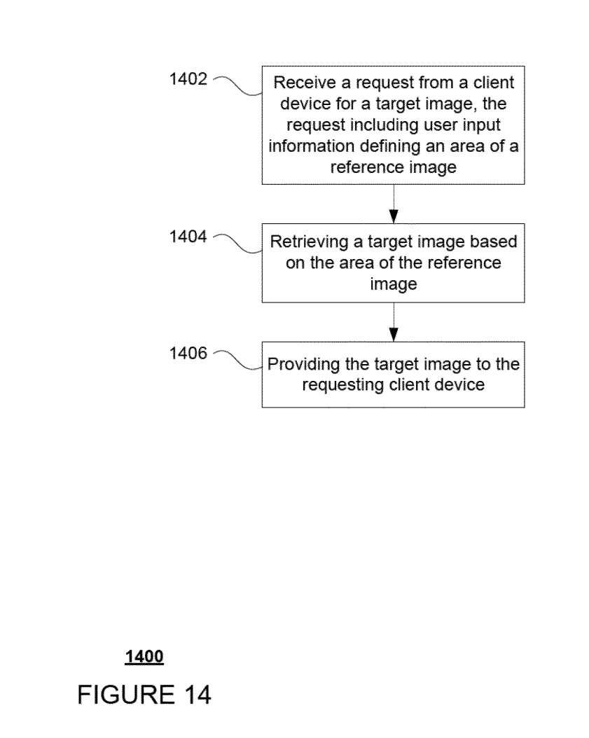

FIG. 14 is an example flow diagram 1400 of additional the aspects described above which may be performed by one or more server computing devices, such as server computing devices 110. In this example, the one or more server computing devices receive a request from a client computing device for a target image at block 1402. The request includes user input information defining a pixel or area of the reference image. The one or more server computing devices retrieve a target image based on the area of the reference image at block 1404. The one or more server computing devices then provide the target image to the requesting client device for display to a user at block 1406. This process may repeat as the user of the client computing device selects pixels or areas of the target image and the one or more server computing devices provide additional target images to the requesting client device for display to the user.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. (canceled)

2. The method of claim 21, further comprising:
receiving user input from a client computing device; and
providing for display, using the one or more computing devices, one of the assigned potential target image to the client computing device based at least in part on the user input indicating a pixel of the reference image having the one of the assigned potential target image.

3. The method of claim 21, wherein each associated cost function is determined as a weighted sum of one or more cost terms.

4. (canceled)

5. The method of claim 1, wherein determining each associated cost function includes determining a centering cost term between the reference image and the particular potential target image, and wherein the centering cost term is configured to be minimized when a projection of the identified area is located at a center of the particular potential target image.

6. The method of claim 21, wherein determining each associated cost function includes determining an alignment cost term between the reference image and the particular potential target image, and wherein the alignment cost term is configured to be minimized when a surface normal from the identified area is located opposite of a viewing direction of the particular potential target image.

7. The method of claim 21, wherein determining each associated cost function includes determining a zoom cost term between the reference image and the particular potential target image, and wherein the zoom cost term is configured to be minimized when a relative zoom value between the reference image and the particular potential target image is equal to a particular zoom factor.

8-11. (canceled)

12. The system of claim 24, wherein the one or more computing devices are further configured to:
receive user input from a client computing device; and
provide for display, using the one or more computing devices, the given target image to the client computing device, wherein the identified area of the reference image is identified based at least in part on the user input.

13. The system of claim 24, wherein the one or more computing devices are further configured to determine each associated cost function by using a weighted sum of one or more cost terms.

14. (canceled)

15. The system of claim 24, wherein the one or more computing devices are further configured to determine each associated cost function by determining a centering cost term between the reference image and the particular potential target image, and wherein the centering cost term is configured to be minimized when a projection of the identified area is located at a center of the particular potential target image.

16. The system of claim 24, wherein the one or more computing devices are further configured to determine each associated cost function by determining an alignment cost term between the reference image and the particular potential target image, and wherein the alignment cost term is configured to be minimized when a surface normal from the identified area is located opposite of a viewing direction of the particular potential target image.

17. The system of claim 24, wherein the one or more computing devices are further configured to determine each associated cost function by determining a zoom cost term between the reference image and the particular potential target image, and wherein the zoom cost term is configured to be minimized when a relative zoom value between the reference image and the particular potential target image is equal to a particular zoom factor.

18-20. (canceled)

21. A computer-implemented method comprising:
identifying, by one or more computing devices, a reference image having a plurality of pixels;
identifying, by the one or more computing devices, a set of potential target images for the reference image;
for each particular potential target image of the set of potential target images, determining, by the one or more computing devices, an associated cost for each pixel of the plurality of pixels based at least in part on a cost function for transitioning between the reference image and the particular potential target image;
assigning each potential target image to a pixel of the plurality of pixels based on the determined associated costs for that potential target image; and
filtering the assigned potential target images based on at least a proximity threshold such that no two pixels of the plurality of pixels having assigned potential target images are within a predetermined distance of one another in the reference image.

22. The method of claim 21, wherein the cost function includes a first overlap value including a first percentage of pixels of the reference image that project into the particular potential target image and a second overlap value including a first percentage of pixels of the particular potential target image that project into the reference image, wherein both the first overlap value and the second overlap value are minimized when the reference image and the target image completely overlap.

23. The method of claim 22, wherein the predetermined distance is a predetermined percentage of an image height of the reference image.

24. A system comprising one or more computing devices configured to:
identify a reference image having a plurality of pixels;
identify a set of potential target images for the reference image;
for each particular potential target image of the set of potential target images, determine an associated cost for each pixel of the plurality of pixels based at least in part on a cost function for transitioning between the reference image and the particular potential target image;
assign each potential target image to a pixel of the plurality of pixels based on the determined associated costs for that potential target image; and
filter the assigned potential target images based on at least a proximity threshold such that no two pixels of the plurality of pixels having assigned potential target images are within a predetermined distance of one another in the reference image.

25. The system of claim 24, wherein the predetermined distance is a predetermined percentage of an image height of the reference image.

26. A non-transitory, tangible computer readable medium on which instructions are stored, the instructions, when executed by one or more processors, cause the one or more processors to perform a method, the method comprising:
identifying a reference image having a plurality of pixels;
identifying a set of potential target images for the reference image;
for each particular potential target image of the set of potential target images, determining an associated cost for each pixel of the plurality of pixels based at least in part on a cost function for transitioning between the reference image and the particular potential target image;
assigning each potential target image to a pixel of the plurality of pixels based on the determined associated costs for that potential target image; and
filtering the assigned potential target images based on at least a proximity threshold such that no two pixels of the plurality of pixels having assigned potential target images are within a predetermined distance of one another in the reference image.

27. The system of claim 26, wherein the predetermined distance is a predetermined percentage of an image height of the reference image.

28. The system of claim 24, wherein the cost function includes a first overlap value including a first percentage of pixels of the reference image that project into the particular potential target image and a second overlap value including a first percentage of pixels of the particular potential target image that project into the reference image, wherein both the first overlap value and the second overlap value are minimized when the reference image and the target image completely overlap.
